(19) United States
(12) Patent Application Publication
(10) Pub. No.: US 2026/0299712 A1
(43) Pub. Date: Oct. 1, 2026

(54) FLEXIBLE CONTROL CYLINDER

(71) Applicant: TRAPPER HOLDING AB, Järfälla (SE)

(72) Inventor: Rolf Eric Ragnar STRÖMBERG, Skä (SE)

(21) Appl. No.: 19/475,793

(22) PCT Filed: Apr. 5, 2024
(86) PCT No.: PCT/SE2024/000002

§ 371 Date: Oct. 16, 2025

(30) Foreign Application Priority Data
Apr. 18, 2023 (SE) 2300030-0

(51) Int. Cl. G06F 3/0354; G06F 3/0362

(52) U.S. Cl. CPC G06F 3/0354; G06F 3/0362

(57) ABSTRACT

A flexible control cylinder (3), and a method of producing such a cylinder (3), preferably intended for a pointing device (1) for moving a cursor on a display, can include a flexible/bendable carrier (6) with strips (5a, b) arranged on the carrier (6) with their imaginary longitudinal axis arranged essentially in the same direction, i.e. parallel to the imaginary center axis of the control cylinder (3). The strips (5a, b) are arranged at a certain distance in relation to each other on at least one side of the carrier (6) and thus acts as a stiffener for the control cylinder (3) in its axial direction, at the same time that the carrier (6) can be bent in a bending zone (10) between the attachment points or attachment surfaces of the strips (5a, b) and that the strips (5a, b) are attached to the carrier (6) using a heat/melt glue (9).

### TECHNICAL AREA

The present invention relates to a tangentially flexible/bendable and axially displaceable cylinder or endless belt, preferably intended to be used as a control cylinder in a pointing device for controlling a cursor on a display. The invention also relates to a method of producing an inventive flexible/bendable control cylinder.

### PRIOR ART

A pointing device such as a mouse or touchpad is a device with which a user can move a cursor on the display of, for example, a computer.

The common and generally used pointing device today is the mouse, which dominates the market for not least desktop computers. However, the mouse has a significant drawback, namely that the user must move his or her hand from the keyboard and place it over the mouse in order to move the cursor on the display. The mouse is also directly unsuitable in cases where a table surface is missing or if the space next to the computer is non-existent or limited.

Also on the market are pointing devices that are placed between the user and the keyboard, designed with a rotatable and displaceable/translatable essentially hard cylinder arranged in a holder. Rotation of the cylinder moves the cursor vertically on the computer display and an axial movement/translation of the cylinder (sideways as seen from the user's perspective) moves the cursor horizontally on the screen.

The advantage of pointing devices of this type is that the user only needs to move his hand a short distance from the keyboard to reach the control cylinder and still, in contrast to so-called touchpads, maintaining the advantage that the response between the movement of the control cylinder and the movement of the cursor on the display is as direct as with a conventional computer mouse. The easier the control cylinder can be moved/rotated, the better the usability.

A disadvantage of pointing devices of this type is that if the control cylinder has a small diameter, the surface that can be operated by the user is also small, which makes it difficult to effectively move the cursor, especially vertically. The larger the diameter with which the control cylinder is made, of course the larger the surface will be that the user can reach, but this at the expense of the design height of the pointing device that has to be made bigger/higher. The consensus among ergonomists is that a pointing device of this type should be thin, i.e. be manufactured with a low construction height, which is not possible if the control cylinder is dimensioned with a large diameter. The trend is also towards ever thinner keyboards and the height of the pointing device should match the height of the keyboard.

A pointing device with a tangentially slightly bendable, but axially rigid, control cylinder according to the Swedish patent SE0201694-7 exists on the market today. The pointing device is located between the user and the keyboard. The control cylinder encloses a sleigh equipped with two rollers, which expand the control cylinder into an oval shape. The sleigh with rollers and control cylinder can slide along a beam in the axial direction of the control cylinder and the control cylinder can rotate around the sleigh and the two rollers. The upper part of the control cylinder rests on the sleigh/beam essentially parallel to the base/table on which the pointing device is placed.

The upwardly directed surface of the control cylinder can be accessed and moved in two directions/dimensions by the user through an opening in the housing of the pointing device, on its upper side, here called operating opening, parallel to the upper support surface of the sleigh/beam. The movement of the control cylinder is detected, for example, optoelectronically, whereby a cursor is electronically caused to move in a corresponding manner on a display. A pointing device based on this technology can be made relatively thin, with a low build height, and with a large access surface for the user.

The construction of the control cylinder is as follows: A bendable/flexible carrier in the form of a rectangle is joined to a control cylinder. The carrier can, for example, consist of a thin Chiffon-type fabric. On the inside of the control cylinder (inward facing side) are axially directed narrow rigid inner strips spaced apart from each other. These inner strips are attached to the carrier using, for example, UV-curing glue and on the outer side of the control cylinder (the side facing outwards) are strings of soft silicone rubber arranged dispensed on the carrier and positioned opposite the inner strips. When each pair of rigid inner strips and outer silicone rubber string are arranged at a tangential distance from their neighboring pairs of strips and silicone rubber strips, bending zones are obtained in there between, where the carrier can be bent freely.

A number of cumbersome and costly manual procedures are required for the manufacture of such a control cylinder, whereby the scrappage has been high, which in turn increases the manufacturing cost. Dispensing the UV-curing glue and silicone rubber also presents a number of different problems. The curing of the glue and the silicone rubber takes time, which extends the production time.

The carrier is cut or punched out as rectangles whereupon the UV curing adhesive is dispensed on one side. Clear cutting then takes place in an axial direction, after which splicing into a control cylinder takes place in an overlap joint. Finally silicone rubber is dispensed in strings on the outside of the control cylinder. All these steps are difficult to perform. The local thickening of the cylinder caused by a lap joint can interfere with the movements of the cylinder around its supporting beam or sleigh with its rollers.

For practical reasons, the glue and silicone rubber strips need to be relatively thick, approx. 0.4 mm, measured in a radial direction from the center of the control cylinder, which means that the weight of the control cylinder becomes so high that it necessitates the described complex arrangement with sleigh and rollers in order for the finished control cylinder to be able to be moved by the user easily enough. It would be a great constructive advantage if the control cylinder could be made with such a low weight that it could be moved easily enough around a fixed beam without the need for a sleigh and rollers.

For the reasons mentioned, there is a great need to improve the technology regarding the pointing device's actuator/cylinder.

### SUMMARY OF THE INVENTION

The object of the present invention is to demonstrate a control cylinder for use with computers, or similar electronic devices, where the above-mentioned problems are solved. The invention also relates to a method for producing such a flexible/bendable control cylinder.

One object is to demonstrate a control cylinder that consists of few and simple components and that can be put together in a quick and simple way and can thereby be manufactured at a low and competitive cost.

A further object is to minimize the weight of the control cylinder, so that the need for complex suspension mechanics for the control cylinder is eliminated and so that the control cylinder can rest against and enclose a simple flat-shaped beam and slide axially along, and rotate about, the beam with low friction.

These and further objects and advantages are achieved according to the invention by a device defined by the features specified in the characterizing part of the independent patent claim 1 and by a method according to the independent patent claim 13.

The upper side of the control cylinder is arranged to be at least partially exposed upwards in an operating opening in the housing of the pointing device so that the control cylinder can be conveniently reached and moved in relation to the surface of the beam by a user. The control cylinder can thus be displaced in an axial direction but also rotated around its imaginary central axis. The movements of the control cylinder are detected using preferably an optical detector, which in turn generates an electrical signal which gives rise to the movement of, for example, a cursor on a display.

The invention is specifically directed towards the design of a control cylinder with long narrow strips arranged on a flexible/bendable carrier in the form of, for example, a textile/weave or a fabric.

According to the present invention, the control cylinder is made up of a number of axially arranged strips, wherein the strips consist of an essentially rigid and foil-shaped material such as plastic, metal or the like. The strips are preferably designed as oblong or long narrow strips but can have any cross-section, for example square, and are firmly applied to at least one side of the carrier by means of an adhesive, preferably a heat/melt adhesive or a UV-curing adhesive.

In a preferred embodiment, the construction is manufactured in such a way that a “sandwich” construction is obtained with the help of the strips and the carrier. In this way, a good rigidity in the axial direction of the control cylinder is achieved, as well as a low weight and low manufacturing cost.

The strips, which can thus be attached to the carrier on one or both sides thereof, are made of an essentially hard/rigid material such as relatively thin plastic or metal. The strips can advantageously be cut (slit) out from a laminating foil that is already coated with a heat/melt glue on one side/surface. Heat/melt glue coated laminating foils are economically and manufacturing advantageous to use as they are available on the market, for other purposes, at a low price. Strips without pre-coated thermal adhesive can, however, be coated with heat/melt glue, alternatively a UV-curing adhesive, in a separate manufacturing step, e.g. by spraying. How the moldings are produced and how the heat or heat/melt glue or alternatively the UV glue is applied to the strips is not decisive for the invention.

If strips with a heat or heat/melt glue are used, the strips are placed so that the heat/melt glue is directed towards the carrier, whereupon the strips are pressed against the carrier under heat and pressure whereby the heat/melt glue heats up and penetrates into the carrier. Difficult dispensing of glue and subsequent time for drying or curing is thereby eliminated, which substantially reduces the manufacturing cost of the control cylinder according to the invention.

If a UV-curing glue is used, the glue is preferably applied to the respective strip on the side to be applied to the carrier. When the strip is located in the correct position, the glue is cured with UV light.

A friction-increasing material, e.g. silicone rubber, can be coated as a layer on the side of the laminating foil not coated with heat/melt glue before cutting/slitting into strips takes place.

The coating of the friction-increasing material thus takes place in a production step before the control cylinder is assembled, which significantly facilitates the control cylinder's production.

Further features and advantages of the invention can be understood from the following, more detailed, description of the invention as well as from the attached drawings and further patent claims.

### SHORT DESCRIPTION OF THE DRAWINGS

The invention is described in more detail below in some preferred embodiments, referring to the attached drawings.

FIG. 1 shows an inventive pointing device in perspective from above, intended to be located in front of a keyboard connected to a computer.

FIG. 2 shows in more detail, and in perspective from above, a control cylinder according to the invention, arranged around a plate or beam along and around which the control cylinder can slide/rotate.

FIG. 3 shows an end view of the control cylinder and the beam according to FIG. 2, whereby it can be seen how a carrier is provided with rigid narrow strips on its outer and inner side.

FIG. 4 shows a cross-section through part of a control cylinder according to the invention, and how laminate strips of different widths are arranged/attached, for example with the help of heat/melt glue or a UV-curing glue, on the outer and inner side of the carrier. The outer wider strips are here only partially attached to the carrier, for example because only part of the glue for each strip has been activated.

FIG. 5a shows in an enlarged cross-section an embodiment where the outer and inner strips have the same width.

FIG. 5b shows the same carrier and strips as shown in FIG. 5a, but the outer strips are here coated with a friction-enhancing substance, at their upper/outer surface, such as silicone rubber to give the user a better grip.

FIG. 6a shows in an enlarged cross-section an embodiment with strips only arranged on the outer surface of the control cylinder.

FIG. 6b shows the same carrier and strips as FIG. 6a, but the strips are here, on their outer surface, coated with a friction-increasing substance such as silicone rubber to create better grip/friction against the user's fingers.

FIG. 7a shows an enlarged cross-section of an embodiment with strips arranged only on the inner surface of the control cylinder.

FIG. 7b shows the corresponding carrier and strips as FIG. 7a, but the carrier, in the area above the inner strips, is here coated with a string of a friction-enhancing substance such as silicone rubber for better grip to the user's fingers. The strips are, for example, attached to the carrier with heat/melt glue.

FIG. 8 shows strips in end view in a position before they have been applied to the carrier. Each strip has a thin layer of heat/melt glue on the surface facing against the carrier.

FIG. 9 shows a flat-lying part of an control cylinder of the same type as, for example, shown in FIG. 5b, where the volume and thus the weight of the friction-increasing material is minimized by a pattern being arranged in the friction-increasing material, here in the form of a waveform.

FIG. 10 shows in perspective an entire control cylinder comprising a spirally wound carrier.

### DESCRIPTION OF EMBODIMENTS

The invention is therefore specifically directed towards the design of a pointing device's control cylinder and its design with stiffening strips arranged on a flexible/bendable carrier.

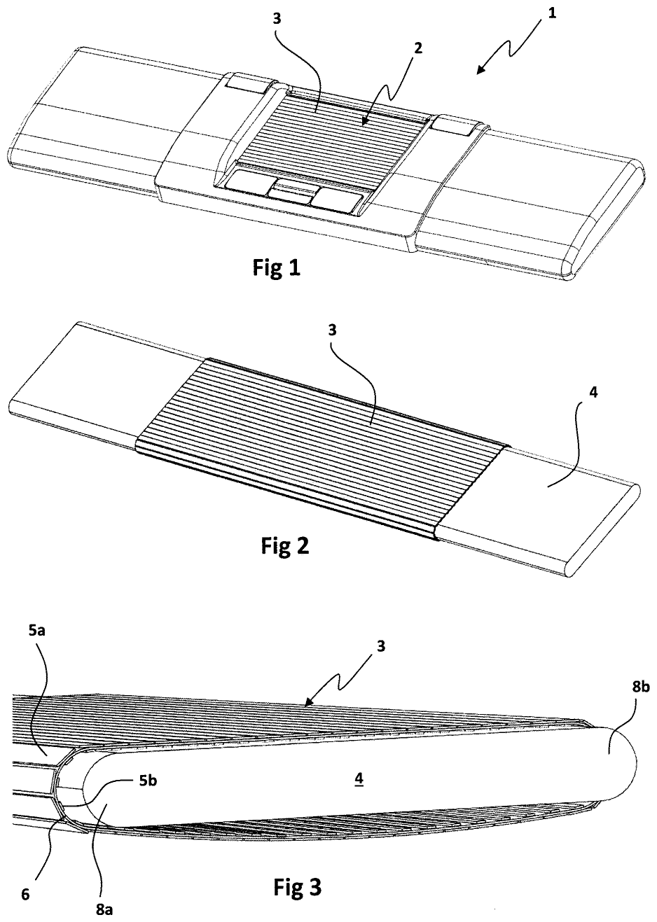

FIG. 1 shows a pointing device 1 according to the invention in perspective from above, intended to be located in front of a keyboard connected to a computer (not shown). The user can easily reach the operating surface 2 of the control cylinder 3 and move it in different directions, whereby the cursor on the computer display is moved in a corresponding manner (not shown).

FIG. 2 shows in more detail, and in perspective from above, an inventive exposed control cylinder 3 arranged around a plate or beam 4 around which the control cylinder 3 can be made to slide and/or rotate. According to the invention, the control cylinder 3 is made up of a number of substantially rigid external and/or internal strips 5a, b (see FIG. 3) arranged in the axial direction of the control cylinder 3 attached to one or both sides of a bendable carrier 6 (see FIG. 3) consisting of, for example a Chiffon fabric.

The strips 5a, b in the control cylinder 3 advantageously consist of a substantially hard or at least rigid material such as a thin plastic or metal. The material can consist of a foil, for example a hard PET foil. The strips 5a, b, which are suitably cut or punched out of the material, can be designed with different thicknesses, advantageously within the range of 0.02 mm to 0.20 mm but are preferably about 0.05 mm thick.

In a preferred embodiment, the adhesive layer is also approx. 0.05 mm thick, which means that the adhesive and the strip 5a, b together have a thickness of only approx. 0.10 mm. The thickness of the adhesive layer can be dimensioned to between 0.02 mm and 0.20 mm.

The width of the inner strips 5b should preferably be dimensioned to about 0.4-1.5 mm in order to minimize the friction against the plate or beam 4. Preferably, the inner strips 5b have a width of about 0.8 mm. The width of the strips 5b can of course also be varied outside the above-mentioned intervals.

FIG. 3 shows an end view of an inventive control cylinder 3 located on a plate or beam 4. In this embodiment, the outer strips 5a are wider than the inner strips 5b and the outer strips 5a are arranged next to each other with a narrow/minimal gap 7 between the long sides of the strips 5a.

As mentioned, the strips 5a, b can be attached to the carrier 6 on one or both sides. In the case that strips 5a, b are arranged on both sides of the carrier 6, they are advantageously located in pairs so that they are oriented above/under, or opposite, each other, i.e. they are “centered” in relation to each other. With the help of the strips 5a, b, the necessary rigidity is achieved in the axial direction of the control cylinder 3, at the same time as sufficient flexibility is achieved during the rotation of the control cylinder 3 when it slides/rotates around a plate or beam 4 and over its side edges 8a, b. The flexibility is achieved by the strip pairs 5a, b being attached to the carrier 6 at a certain but small distance from each other, which allows the carrier 6 to bend freely between the attachment of the strips 5a, b to the carrier 6. FIG. 4 shows in an enlarged cross-section a part of the control cylinder 3 according to e.g. FIG. 3 and in more detail, the construction with strips 5a, b arranged on each side of the carrier 6, which in turn rests against a plate/beam 4. The carrier 6 is very flexible/bendable and is advantageously manufactured from, for example, a textile, a weave or a fabric, preferably as mentioned of Chiffon type.

The strips 5a, b are attached to the carrier 6 preferably with heat/melt glue or UV-curing glue 9. Other glue can of course also be used, but this entails a more cumbersome, and thus more expensive, manufacturing process. Only the surfaces of the outer strips 5a which are arranged opposite the inner strips 5b are here glued to the carrier 6. In this way, sufficiently wide bending zones 10 are arranged in the carrier 6. The entire underside of the outer strips 5a, the side that is directed against the carrier 6, can be provided with heat/melt glue 9, but only parts of this glue are activated in this embodiment.

A bending zone 10 can thus, by gluing the carrier 6 only to the central part of the lower surface of the outer strip 5a, be arranged to extend under the wider outer strip 5a and in that way both allow a necessary/desired bending of the carrier 6, yet the strip 5a covers and protects the carrier 6, also in the bending zone 10, against surrounding dust and dirt and at the same time the strips 5a give the impression of an almost complete and homogeneous upper/outer surface of the control cylinder 3 which the user can easily maneuver using their fingers.

By central part is meant here that the strip 5a is glued to the carrier 6 along part of its surface, the attachment surface, preferably in the middle of the strip 5a, seen from an end view of the strip. The width of the glued surface is typically smaller than the entire width of the strip 5a and the bending zone 10 thus extends under the long sides of the strip 5a. The glued surface, the attachment surface, preferably extends along substantially the entire length of the strip 5a.

The inner strip 5b are therefore located in this design example positioned opposite the outer strip 5a and are thus centered in relation to them, i.e. the longitudinal imaginary center line of the strip are located in the same place on the carrier 6 only with the difference that the outer strip 5a is located on the carrier's upper/outer side and the inner strip 5b is located on the inner side of the carrier 6. The width of the inner strip 5b is, in this particular embodiment, suggested to be approximately 30% of the width of the outer strip 5a.

The distance, the gap 7, between outer strips 5a located next to each other can of course be dimensioned with different widths but is preferably equal to or less than about 0.5 mm.

By orienting the outer strips 5a next to each other with their longitudinal edges but only being attached with a part of their surface facing directed towards the carrier 6, it is achieved that the outer user surface, the so-called mantle surface, is perceived as essentially whole/homogeneous and it is also thus essentially sealed against dirt, grease and dust which, over time, can otherwise pose a serious problem for the function of the pointing device 1. The carrier 6 is thus protected by the placement of the outer strips 5a close to each other, against contamination. Despite that, the present invention enables the flexibility of the control cylinder 3 to be maintained by bending zones 10 being arranged in the carrier 6 between the attachments surfaces of the strips 5a, b, with only part of its lower surface glued to the carrier 6, which in turn enables the control cylinder 3 to easily rotate around e.g. the rounded side edges 8a, b of the plate/beam 4.

The part of the lower surface of the outer strips 5a which is attached/glued to the carrier 6 can advantageously substantially correspond to the entire width of the inner strips 5b, but of course need not do so.

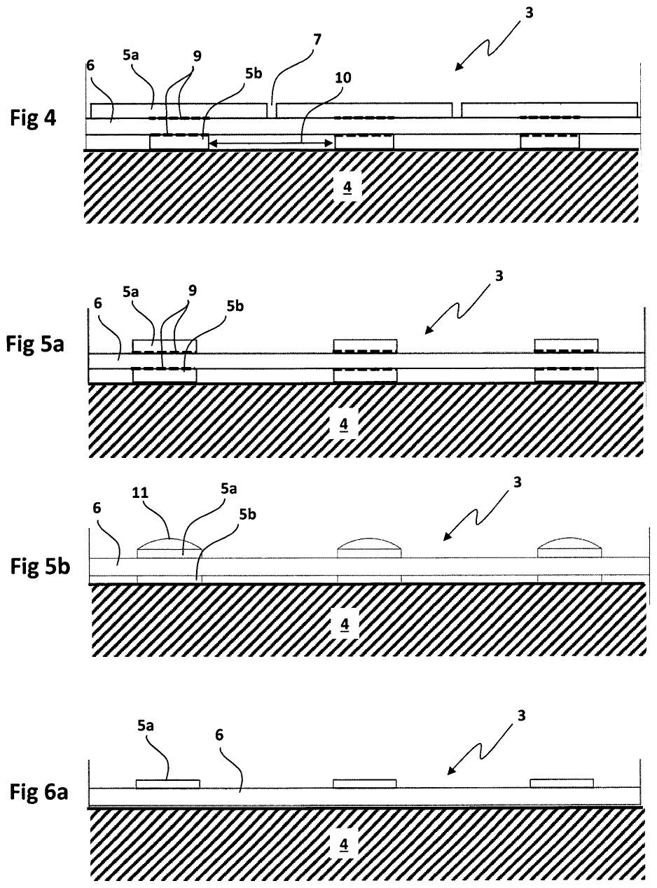

FIG. 5a shows in an enlarged cross-section an embodiment where the outer and inner strips 5a, b have the same width. Here, it is assumed that the friction between the inner strips and the beam 4 is so low that the control cylinder 3 can easily slide against the beam 4 and that the friction between a user's fingers and the outer strips 5a is so high that the control cylinder 3 can be moved without difficulty by a user.

FIG. 5b shows essentially the same carrier 6 and strips 5a, b as shown in FIG. 5a, but the outer strips 5a are here provided at their upper/outer surface with a friction-increasing coating 11, such as, for example, silicone, rubber or a material with similar properties, to give the user a better grip.

In FIGS. 3 to 5b, strips 5a, b are attached to both sides of the carrier 6, resulting in a local “sandwich construction” where the resulting axial stiffness of a pair of strips, an outer and an inner strip 5a, b attached to the carrier 6, substantially exceeds the sum of the stiffness of the individual strips 5a, b. Therefore, the thickness of the individual strips 5a, b can be chosen relatively thin for a desired and optimal axial stiffness, which minimizes the total weight of the control cylinder 3. Light weight minimizes the friction of the control cylinder 3 against the plate/beam 4 it encloses, which in turn makes it easier for a user to move the control cylinder 3.

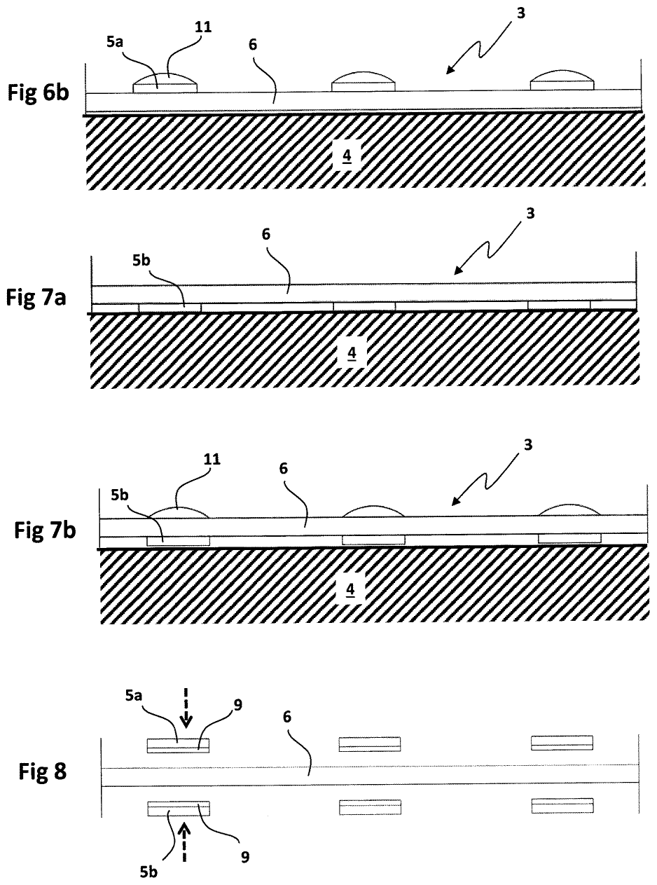

FIG. 6a shows in an enlarged cross-section an embodiment with strips 5a only arranged on the upper/outer surface of the control cylinder 3. Here, it is assumed that the friction between the carrier 6 and the plate/beam 4 is so low that the carrier 6 can easily slide against the plate/beam 4 and that the friction between a user's fingers and the outer strips 5a is so high that the control cylinder 3 can be easily moved by a user. The outer strips 5a are here manufactured with a thickness of their own which ensures that the control cylinder 3 becomes sufficiently rigid in the axial direction. The strips 5a are also advantageously attached to the carrier 6 with heat/melt glue or UV-curing glue.

FIG. 6b shows the corresponding carrier 6 and strips 5a as FIG. 6a, but the strips 5a are here, on their upper/outer surface, provided with a friction-increasing coating 11 such as, for example, silicone rubber to create better attachment/friction against the user's fingers.

FIG. 7a shows an enlarged cross-section of an embodiment with strips 5b arranged only on the inner/lower surface of the control cylinder 3. It is assumed here that the friction between a user's fingers and the carrier 6 is high enough for the control cylinder 3 to be able to be moved by the user. In this embodiment, the inner strips 5b are made of a slightly thicker material than in the case where you have strips 5a, b on both sides of the carrier 6, for example approx. 0.4-0.5 mm, but should be within the range of 0.2-0.8 mm, and thus ensures that the control cylinder 3 becomes sufficiently rigid in the axial direction. Here, too, the strips 5b are attached to the carrier 6 with heat/melt glue 9 or a UV glue. The strips 5a, b can of course be made thicker, but then at the expense of the actuating cylinder 3 becoming heavier and thus less optimal for the user to handle, and it also means that the pointing device gets an increased construction height, which one wishes to minimize.

FIG. 7b shows the corresponding carrier 6 and strips 5b as in FIG. 7a, but the carrier 6, in the area above the inner strips 5b, is here coated with dots or strings of a friction-increasing substance such as silicone rubber for better grip to a user's fingers.

FIG. 8 shows strips 5a, b in end view in a position before they have been applied to the carrier 6. Each strip 5a, b has a thin layer of heat/melt glue 9 on the surface facing the carrier 6. The manufacture then proceeds so that the strips 5a, b are pressed/mangled against the carrier 6 while applying heat, whereby the heat/melt glue 9 melts and partially penetrates into the carrier 6. The control cylinder 3 is then allowed to cool, whereby the heat/melt glue 9 solidifies and effectively attaches the strips 5a, b to carrier 6.

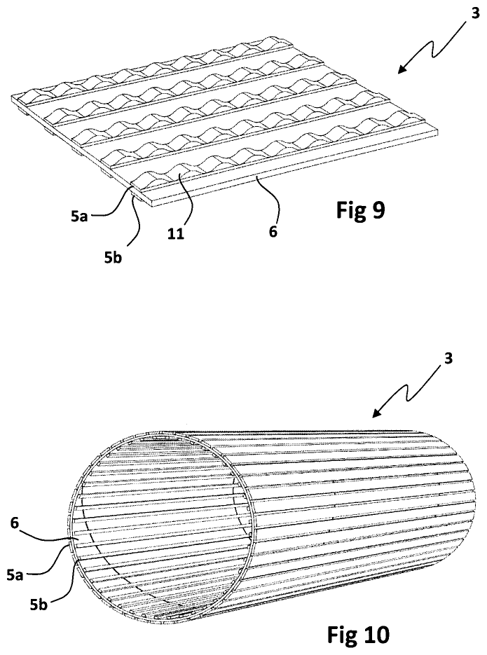

FIG. 9 shows a flat part of a control cylinder 3 of the same type as, for example, shown in FIG. 5b, where the volume and thus the weight of the friction-increasing material 11 is minimized by arranging a pattern in the friction-increasing material 11, here in the form of a waveform. Due to the height of the “tops”, the friction-increasing material 11 keeps the user's skin at a sufficient distance from the carrier 6, which minimizes the risk of hand grease and dirt from the user's fingers reaching the carrier 6 and thus being able to penetrate it. The average height is thus less than the maximum height seen in the axial extension of the strips 5a, b, which minimizes the total weight of the control cylinder 3. The outer/upper surface of the outer strips 5a, and/or the friction-increasing coating 11 arranged on the outer strips (5a), is thus designed with an uneven, wavy or profiled surface.

FIG. 10 shows in perspective an entire control cylinder 3 where the carrier 6 is spirally wound. In a preferred embodiment, the carrier 6 is made of a fabric, preferably of the Chiffon type. Such a fabric is usually delivered in approximately 1.5 m wide rolls (not shown). The fabric is cut, before the manufacturing of the control cylinder 3, into long strips preferably with a width of approximately 70% of the desired circumference of the control cylinder 3, in section along the warp of the fabric. The strip is arranged/wound in spiral form, whereby a relatively stiff/stable control cylinder 3 is obtained due to the fact that the fabric's warp and weft then form an angle of about 45 degrees to the imaginary center axes of the strips 5a, b and the control cylinder 3.

This enables a very rational production as the moment of cutting out a rectangle which is to form the carrier 6 is omitted, as well as the moment of splicing the rectangles together in an overlap joint to a cylinder.

A preferred embodiment of the invention is thus a flexible control cylinder 3, preferably intended for a pointing device 1 for moving a cursor on a display screen, comprising a flexible/bendable carrier 6, consisting of a weave or fabric, and a number of strips 5a, b arranged on the carrier 6 with the imaginary longitudinal axis of the strips 5a, b arranged essentially in the same direction as the imaginary center axis of the control cylinder 3, and characterized by the fact that the strips 5a, b are made of a thin material such as, for example, a foil of hard plastic, metal or of a material with similar substantially rigid properties, that the strips 5a, b are arranged on both sides of the carrier 6 to create a local sandwich effect which results in an increased axial stiffness of the control cylinder 3, that the strips 5a, b, an outer strip 5a and an inner strip 5b, are arranged in pairs on the carrier 6, wherein the outer strips 5a, arranged on the outside of the carrier 6, are centrally arranged in relation to the inner strips 5b, arranged on the inside of the carrier 6, and that the pairs of strips 5a, b are arranged at a distance in relation to each other, whereby bending zones 10 are formed between the pairs of strips 5a, b.

The invention also relates to a method of manufacturing a flexible control cylinder 3, preferably intended for a pointing device 1 for moving a cursor on a display screen, comprising a flexible/bendable carrier 6 consisting of a weave or fabric, and a plurality of strips 5a, b arranged on the carrier 6 with the imaginary longitudinal axes of the strips 5a, b arranged essentially in the same direction as the imaginary central axis of the control cylinder 3. The method include that the strips 5a, b are made of a thin material such as for example a foil of hard plastic, metal or of a material with similar substantially rigid properties, are mounted on both sides of the carrier 6 to achieve a local sandwich effect that results in an increased axial rigidity of the control cylinder 3, that the strips 5a, b, an outer strip 5a and an inner strip 5b, are mounted in pairs on the carrier 6, whereby the outer strips 5a, mounted on the outside of the carrier 6, are centered in relation to the inner strips 5b, mounted on the inside of the carrier 6, and that the pairs of strips 5a, b are mounted at a distance in relation to each other, whereby bending zones 10 are formed between the pairs of strips 5a, b.

The description above is primarily intended to facilitate the understanding of the invention and the invention is of course not limited to the specified embodiments, but also other variants of the invention are possible and conceivable within the scope of the invention and the following patent claims. The invention may also be used for purposes other than pointing devices.

1. A flexible control cylinder (3) for a pointing device (1) for controlling a cursor on a display, comprising a flexible or bendable carrier (6) consisting of a weave or fabric, and a plurality of strips (5a, b) arranged on the carrier (6) with an imaginary longitudinal axis of the strips (5a, b) arranged essentially in the same direction as an imaginary central axis of the control cylinder (3), wherein:
the strips (5a, b) are made of a thin material,
the strips (5a, b) are arranged on both sides of the carrier (6) to create a local sandwich effect that results in an increased axial stiffness of the control cylinder (3), and
an outer strip (5a) and an inner strip (5b) of each of the strips (5a, b) are arranged in pairs on the carrier (6), and
wherein the outer strips (5a), arranged on an outside of the carrier (6), are centrally arranged in relation to the inner strips (5b), arranged on an inside of the carrier (6), and that the pairs of strips (5a, b) are arranged at a distance relative to each other, whereby bending zones (10) are formed between the pairs of strips (5a, b).

2. The flexible control cylinder (3) according to patent claim 1, wherein,
the strips (5a, b) are coated with a heat/melt glue.

3. The flexible control cylinder (3) according to claim 1, wherein,
the strips (5a, b) have a thickness of 0.02 mm to 0.20 mm, but preferably about 0.05 mm.

4. The flexible control cylinder (3) according to claim 1, wherein,
the outer strips (5a) are attached to the carrier (6) only along part of its surface directed towards the carrier in such a way that their outer longitudinal edge portions are freely arranged in relation to the carrier (6).

5. The flexible control cylinder (3) according to patent claim 4, wherein,
the outer strips (5a), located on the outside of the carrier (6), have a greater width than the inner strips (5b) which are arranged on the inside of the carrier (6).

6. The flexible control cylinder (3) according to claim 4, wherein,
the outer strips (5a) are attached to the carrier (6) only along a surface that essentially corresponds to the surface of the corresponding inner strip's (5b) attachment to the carrier (6), regardless of the overall width of the outer strip (5a).

7. The flexible control cylinder (3) according to claim 4, wherein,
a gap (7) between the outer strips (5a), on the outer side of the carrier (6), is equal to or less than 0.5 mm.

8. The flexible control cylinder (3) according to claim 1, wherein,
a width of the inner strips (5b) is between 0.4-1.5 mm.

9. The flexible control cylinder (3) according to claim 1, wherein
an outer or upper surface of the outer strips (5a) is completely or partially provided with a friction-increasing coating (11).

10. The flexible control cylinder (3) according to patent claim 9, wherein,
the outer or upper surface of the outer strips (5a), or the friction-increasing coating (11) arranged on the outer strips (5a), is designed with an uneven, waved or profiled surface.

11. The flexible control cylinder (3) according to claim 1, wherein,
the carrier (6) consists of a strip of fabric arranged in a spiral way.

12. The flexible control cylinder (3) according to patent claim 11, wherein,
a width of the strip of fabric is approx. 70% of the control cylinder's (3) circumference.

13. A method for manufacturing a flexible control cylinder (3), intended for a pointing device (1) for moving a cursor on a display, comprising a flexible or bendable carrier (6) consisting of a weave or fabric, and a plurality of strips (5a, b) arranged on the carrier (6) with an imaginary longitudinal axes of the strips (5a, b) arranged essentially in the same direction as an imaginary central axis of the control cylinder (3), wherein,
the strips (5a, b) are made of a thin material and are mounted on both sides of the carrier (6) to achieve a local sandwich effect that results in an increased axial stiffness of the control cylinder (3),
an outer strip (5a) and an inner strip (5b) of each of the strips (5a, b) are mounted in pairs on the carrier (6),
whereby the outer strips (5a), mounted on the outside of the carrier (6), are centered in relation to the inner strips (5b), mounted on the inside of the carrier (6), and
the pairs of strips (5a, b) are mounted at a distance in relation to each other, whereby bending zones (10) are formed between the pairs of strips (5a, b).

14. The method according to patent claim 13, wherein,
the strips (5a, b) are cut to size or punched out of a plastic or metal foil that is already coated with a heat/melt glue (9).

15. The method according to claim 13, wherein,
the flexible carrier (6) is arranged or wrapped in a spiral.
